(19) United States
(12) Patent Application Publication
(10) Pub. No.: US 2005/0251314 A1
(43) Pub. Date: Nov. 10, 2005

(54) Window lifter and method for the control of a window lifter of a power-driven vehicle

(75) Inventors: Thomas Schindler, Grossheirath (DE); Detlef Russ, Ebersdorf (DE); Martin Lieb, Rodental (DE); Jochen Held, Forchheim (DE); Roland Kalb, Rossach (DE)

Correspondence Address: Jacob Eisenberg, Seerainstrasse 3a, Steckborn, CH-8266, CH

(73) Assignee: BROSE FAHRZEUGTEILE GMBH & CO. KOMMANDITGESELLSCHAFT, COBURG (DE)

(21) Appl. No.: 11/126,396

(22) Filed: May 11, 2005

(30) Foreign Application Priority Data
May 5, 2004 (DE) 20 2004 007 158

(51) Int. Cl. G06F 17/00

(52) U.S. Cl. 701/49

(57) ABSTRACT

A controlling device with a sensor for the detection of a position of a window pane of the window lifter depending on a driving motion of an actuation is provided. The position signals generated by the sensor, for example by a path sensor or rotary pulse sensor, concern thereby the position of the window pane. Position signals are for example gained from a waviness of a driving power of a mechanically commuted electromotor. The sensor signals can thereby be evaluated by the controlling device. The controlling device includes an analogue or a digital computer unit which provides a function for the combined evaluation of the current position of the window pane and a condition of a roof of the motor vehicle. The evaluation can thereby occur for example by a respective logical circuit as computer unit, by a hard-wired program logic as computer unit or by a programmable computer unit.

### CROSS REFERENCE TO RELATED APPLICATIONS

The present application claims priority to German patent application 20 2004 007 158.4, filed May, 2004, which is herein incorporated by reference.

### BACKGROUND OF THE INVENTION

The invention concerns a window lifter a controlling device of a window lifter and a method for the control of a window lifter of a power-driven vehicle. A method is known from the DE 197 45 597 A1 for the control and regulation of the regulating motion of a translatory adjustable component, especially of a window lifter in power driven vehicles. An efficient crush protection considering also a sufficient adjustment force in restriction areas and forces affecting the vehicle body, conditioned by external forces is guaranteed by this method for the control and regulation of the regulating motion of the translatory adjustable component, with a regulating device, a driving device and controlling electronics. The driving device exercises such a regulating force, which equals the sum for the necessary force for the adjustment of the component and is a superfluous force, whereby the sum is smaller or equal to a permitted crush force. The adjustment force or the superfluous force is additionally regulated in dependence from forces affecting the body of the vehicle or pieces thereof.

The solution guarantees a crush protection beyond the entire adjustment area, which also fulfils very high safety requirements. Additionally, it is assured that the regulating force is also sufficient in restriction area and that a regulating device adjusts a translator adjustable component gently on the material and considering the externally affecting influences on the vehicle body according to the specification of the operator. The forces affecting the vehicle body or the acceleration forces are hereby understood as external forces, which are not immediately caused by the regulating device or by a driving device, but for example occur because of the bad condition of a road (driving over a hole) or at closing the vehicle door.

The regulation of the adjustment force or the superfluous force occurs preferably in dependence from the moving direction of the translatory adjustable component and from the acceleration forces occurring by the predominantly direction of affect in such a way, that the adjustment force is always smaller or equal to the permitted crush force. If an acceleration force for example affects the vehicle body, which supports the closing motion of a translatory adjustable component, the threshold is preferably decreased. In the case of the occurrence of an acceleration force directed against the closing motion, the threshold is increased. The adjustment force is always sufficient this way, so that the closing motion is securely continued and a crush protection is guaranteed.

It is furthermore provided, that at occurrence of changing acceleration forces effecting the vehicle body within a determined time frame, a regulation of the adjustment force or the superfluous force is interrupted and a threshold is preset in such a way that the adjustment force is always smaller or equal to the permitted crushing force. The time frame may be 100 ms. This kind of execution takes into consideration that the threshold does not always change within a short time frame at ever changing acceleration forces affecting the vehicle body, which could lead to a impairment of the movement of the translatory adjustable component. By pre-setting a fixed threshold, which is always smaller or equal to the permitted crush force, both a secure movement of the translatory adjustable component as well as a crush protection are guaranteed.

The acceleration forces affecting the vehicle body are detected preferably by a sensor, for example by a sensor delivering digital signals. Digital signals can be further processed in control regulation electronics. For the adjustment of the regulation one or more, time-related successive signals of the sensor can be evaluated by the control and regulation electronics. The repeated evaluation of the sensor permits safe identification of a simultaneous occurrence of the acceleration forces caused by external influences and the forces conditional by a crush case.

A driving device for a motor driven vehicle is known from DE 195 17 958. The rotation of the drive is immediately stopped at the driving device for an electric window lifter, if an obstacle is put against the movement of the window, at turned motor. The driving device serves for the opening and closing of the moveable piece (window) and can be selectively started and stopped.

An electrical power meter device measures the power of the power running through the drive in a starting compensation time, a current power changing detector device determines a current power increment from the determined power at each constant time frame, and a driving controlling device delivers a first or a second control signal to the driving device, whereby the driving operation is continued with the first signal depending from the polarity of the current power increment and the drive is immediately stopped with the second signal of the drive.

Two selection switches mark the direction of the drive, a pair of push-buttons for the respective driving directions and two self-changing switches for the two directions of the drive enable a rotation of the motor at an actuating one of the push-buttons.

It is a task of the present invention to improve a controlling device of a adjustment device as much as possible. This task is solved by the method to control a window lifter with the characteristics of claim 1, by the controlling device with the characteristics of claim 19, the window lifter with the characteristics of claim 40, by the computer program product with the characteristics of claim 37. Advantageous further developments of the invention are indicated in the dependent claims. In additions, for a further development of the invention, the characteristics of the dependent claims are combined especially among each other as well as with the characteristics of the indicated state of the art.

Accordingly, a controlling device with a sensor for the detection of a position of a window pane of the window lifter depending on the driving motion of an actuation of a window lifter is provided. The position signals generated by the sensor, for example a path sensor or momentum sensor, thereby concern the position of the window pane. These counting pulses, for example, for a selected position value are preferably proportional to the position. The position signals, for example, are gained from a waviness of a driving current of a mechanically commuted electromotor. The sensory signals are thereby readable by the controlling device.

The controlling device includes an analog, or preferably a digital, computer unit for this, which has a function for the combined evaluation of the current position of the window pane and a condition of a cape roof of the motor vehicle. The evaluation can thereby occur for example by a respective logical circuit as computer unit, by a hard-wired program logic (ROM) as computer unit or by a programmable computer unit.

The invention thereby comprises the control of the window lifter by determining the position of a window pane of the window lifter and controlling an actuation of the window lifter in dependence from the determined position. The current position and a condition of a cape roof of the motor vehicle are thereby evaluated in combination for the control.

In a further development of the invention, the current position is evaluated in dependence from the condition of the cape roof for the function of the combined evaluation. The computer unit therefore includes a function of evaluation of the current position in dependence from the condition of the cape roof. The information about the current position for example in dependence from the condition of the cape roof is differently weighted or allocated for the evaluation. The result of the evaluation enables the control of different operating modes, such as the normalization or denormalization of a particularly successive blockage of the adjustment and/or the activation or deactivation of a crush protection algorithm and/or the modification of parameters of the crush protection algorithm.

A first variant of the invention provides that the condition of the cape roof is a current cape roof position of a particularly motive flexible cape roof. Possible cape roof positions are for example: “Cape roof completely closed”, “cape roof completely opened”, “cape roof partially closed” or “cape roof closed and not locked”.

The controlling device includes an interface in an advantageous embodiment of the present invention, especially in the execution of buses, for example of a CAN-bus or LIN-bus of the motor vehicle. A signal characterizing the condition of the roof is transmitted to the controlling device developed for the control by this interface. The computer unit is thereby installed to evaluate this transmitted signal.

The second invention variant provides that the condition of the roof is determined by a plausibility check of the current position of the window pane. It is a condition, that the possibility to start certain adjustment positions of the window pane depend on the condition of the roof. If for example the setting range of the window pane for an opened roof to the upper mechanical setter of the window lifter is enabled, while the setting range is restricted by a blockage of the adjusting motion of the window pane at the roof in case of the closed roof, the information can for example be gained by the plausibility check, that the roof is at least partially opened, if the window pane is adjusted beyond the expected blockage at the roof.

A further development of this second invention variant is that the condition of the roof is determined by evaluation of the blocking characteristic at the off position of the window pane. If for example a speed course, characteristic for the run-in of the window pane edge into the sealing of the roof, is determined, the respective current roof position is allocated to this event and for example a normalization is carried out. The blocking characteristic is additionally or alternatively to be allocated to different roof types (hardtop, soft top) to adjust the control of the window pane.

Based on errors at the determination of the position of the window pane, shifts between the position determined by the controlling device and the actual position of the window pane are caused. To be able to distinguish in case of a blockage of the adjusting motion between a squeezed body part and a blockage at the stop position of the roof, a sufficiently precise determination of the actual position of the window pane edge regarding the stop position of the roof is necessary. Errors at the determination of the position increase the risk of an incorrect rating of the actual position by the controlling device, which increases the danger of squeezing a body part or an incorrect reversing of the window pane at the stop position of the roof. To reduce this danger, the position of the window pane is preferably repeatedly scaled regarding the stop position of the roof.

An advantageous further development of this variant of the invention provides a normalization and/or denormalization of the determined position regarding a pane off position in dependence from the condition of the roof. The pane off position is thereby particularly the stop position of the roof or the mechanical stop position of the window pane, if the carrier fixated to the pane is moved to the upper stop position of the window lifter rail. These two stop positions are normally offset locally in direction of the setting range. A normalization thereby occurs preferably at the stop position of the roof, if this is in closed condition.

Preferably, a denormalization does not occur when a blockage is recognized and the condition of the roof is detected as open. The current normalization point of the previously determined position of the stop position of the closed roof is kept in this case and is used preferably as an initial value, when the roof is closed again and the window pane is moved into the blockage position at the stop position of the roof.

In a further embodiment of the present invention, the condition of the roof is a type of the roof, particularly a hardtop or soft top. In the sense of the invention, the type of the roof can thereby—alternatively be combined with the roof position—to create the condition of the roof. The control device thereby uses the information, which roof construction is built to control the respective window lifter or several window lifters.

Preferably, a closing motion of the window lifter is stopped for the control if the crushing of an object or a body part is detected by the closing motion within a detection position area. Additionally, the adjustment direction of the window pane can be reversed after the stopping to release the crushed object or the crushed body part.

Parameters depending from the driving motion are hereby preferably evaluated by a detection algorithm for the detection. One or more parameters of the detection algorithm are adapted in an advantageous further development of the invention in dependence from the condition of the roof, particularly in dependence from the type of the roof. Such parameters are preferably dependent from the expected restriction during the run-in of the window pane edge into the sealing of the roof.

A further development of the invention provides that the parameter(s) influence the responsiveness of the detection algorithm particularly in such a way that the responsiveness is modified in dependence from the type of the roof. The responsiveness is thereby for example a constant threshold value or preferably a variable, position dependent threshold value, which considers possible restrictions in at least one end area of the setting range. A course of the threshold value depending on the position of the sealing of the roof is for example provided so that the responsiveness is reduced with increasing run-in of the window edge into the sealing of the roof.

The parameter(s) allocated to the condition, particularly to the type of the roof, are preferably read-out from a memory in dependence from the condition of the roof. Different parameter values are thereby allocated different conditions of the roof in the memory. Several parameters form thereby preferably a mapping for the responsiveness.

A further advantageous design of the invention provides that at least one of the parameters forms an offset position for the responsiveness. If for example an identical course of the responsiveness is given about the position gaps in the setting range of the window pane for different conditions of the roof, the responsiveness is adapted to the position significant for the condition of the stop position of the roof with the support of the position shifting.

The computer unit is preferably developed to adapt the parameter(s) in dependence of one or several previous settings. The adaptation enables an adjustment to different temperatures or modifications of mechanical systems about the service life of the motor vehicle. The computer unit is preferably designed to adapt parameter(s) to evaluate, particularly to average position-dependant speeds or position-dependant restrictions. A dynamic adjustment of the parameters, which especially determine a reversing criterion, is hereby possible. The reversing criterion is preferably a threshold value which is part of the mentioned detection algorithm. The responsiveness is adjusted by the dynamic adjustment of the parameter by this reversing criterion.

The invention further comprises a digital memory medium, especially a disc or a memory chip, with electronically reads-out control signals, which can cooperate with a programmable computer unit in such a way that the position of window pane of the window lifter is determined and an actuation of the window lifter is controlled in dependence from the determined position, whereby the current position and a condition of the roof of the motor vehicle are evaluated in combination for the control.

Furthermore, the invention comprises a computer program product with a machine readable carrier, particularly a semiconductor memory, memorized program code for the control of a window lifter of a motor vehicle, by determining the position of the window pane of the window lifter and an actuation of the window lifter in dependence from the detected position, whereby the current position and a condition of a roof of the motor vehicle are evaluated in combination for the control if the program runs on a computer unit.

The invention also comprises a computer program with a program code for the control of a window lifter of a motor vehicle, by determining the position of a window pane of the window lifter and by controlling an actuation of the window lifter in dependence from the determined position, whereby the current position and a condition of the roof of a motor vehicle is evaluated in combination, for the control, if the program runs on a computer unit.

An object of the invention is also a window lifter of a motor vehicle with a controlling device which comprises at least one sensor for the detection of a position of a window pane of the window lifter depending on a driving motion of an actuation of the window lifter, and a computer unit which provides a function for the combined evaluation of the current position of the window pane and a condition of a roof of the motor vehicle.

### BRIEF DESCRIPTION OF THE SEVERAL VIEWS OF THE DRAWINGS

The present invention is set out below in more detail with example embodiments supported by the attached figures, wherein:

FIG. 1 depicts a controlling device with controlling electronics for the control of an electromotor of a window lifter, and

FIG. 2 depicts a schematic functional course for different roof types.

### DETAILED DESCIRPTION OF THE INVENTION

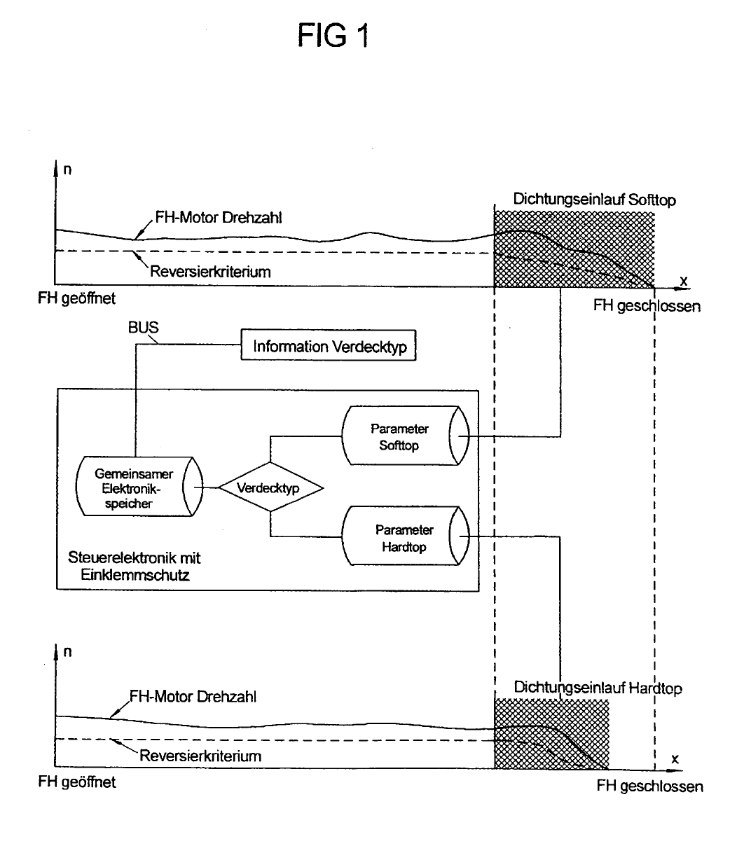

A controlling device of a window lifter of a motor vehicle is shown in FIG. 1. The controlling device comprises controlling electronics with a crush protection function. The controlling electronics are additionally connected by a bus with further functional units of the motor vehicle, whereby an information about the installed roof type for the controlling electronics of the controlling device is transmittable by the bus. The controlling electronics show a common electronics memory, where at least the data necessary for the crush protection is saved, recordable and can be read-out by algorithms.

The controlling device also provides a sensor detector of a position of a window pane of the window lifter depending on a driving motion of an actuation of the window lifter. The position is shown in the lower and upper area of FIG. 1, which shows the course of the rotary frequency n of the window lifter motor of the detected position x. A computer unit of the controlling electronics (not shown in FIG. 1) provides a function for the combined evaluation of the current position x of the window pane and a condition of a roof of the motor vehicle.

The computer unit provides a detection algorithm for the detection of at least one parameter dependent from the driving motion. This parameter is the rotary frequency n of the window lifter motor M in the FIG. 1 shown in this embodiment of the invention. If the rotary frequency n of the window lifter motor M remains under a reversing condition, as shown in FIG. 1, which is for example displayed by a threshold of the detection algorithm, then the crushing of an object or a body part is detected and the controlling electronics stops the then closing motion of the window lifter. Afterwards, the actuation of the window lifter motor is operated towards opening, so that the adjustment direction of the window pane reverses. Another signal depending on the driving motion, as preferably the driving power or the temporal modification of the rotary number dn/dt, can also be compared with a reversing criterion, instead of the rotary number n for the evaluation.

The reversing criterion acting as a threshold, which is shown in the upper and lower area of FIG. 1, is determined by several parameters which may all be stored in a common memory. The memory is for example a read-only memory (EEPROM), which also receives a storing of the parameters for the detection of a crushing event as well as for the case of a failing power supply. With the information about the installed roof type transmitted by the buses to the controlling electronics, the parameters of the reversing criterion to the used roof type are read out by the controlling electronics in dependence from the installed roof type and recorded into a register of the micro controller of the controlling electronics for the control of the actuation.

The parameters for a soft top define the course of the reversing criterion shown in the upper part of FIG. 1, but the parameters which belong to a hardtop define the course of the reversing criterion in the lower area of FIG. 1. In the depicted example, the run-in of the window pane into the sealing of a soft top is different than the run-in into the sealing of a hardtop, as shown in the lower area of FIG. 1. While in the case of a soft top the rotary number of the window lifter motor decreases essentially slower, the mechanical system with an installed hardtop is less elastic, as shown in the lower area of FIG. 1.

This results in respective adjustment of the reversing criterion to the different moving courses for these different roof types during the run-in of the window pane edge into the sealing of the soft top, and in particular, the hardtop, to avoid a false reversing and to reduce the crushing risk. Depending on which roof type is used, an optimal adjustment of the reversing criterion to the expected modification of the rotary number of the window lifter motor in the area of the sealing is possible.

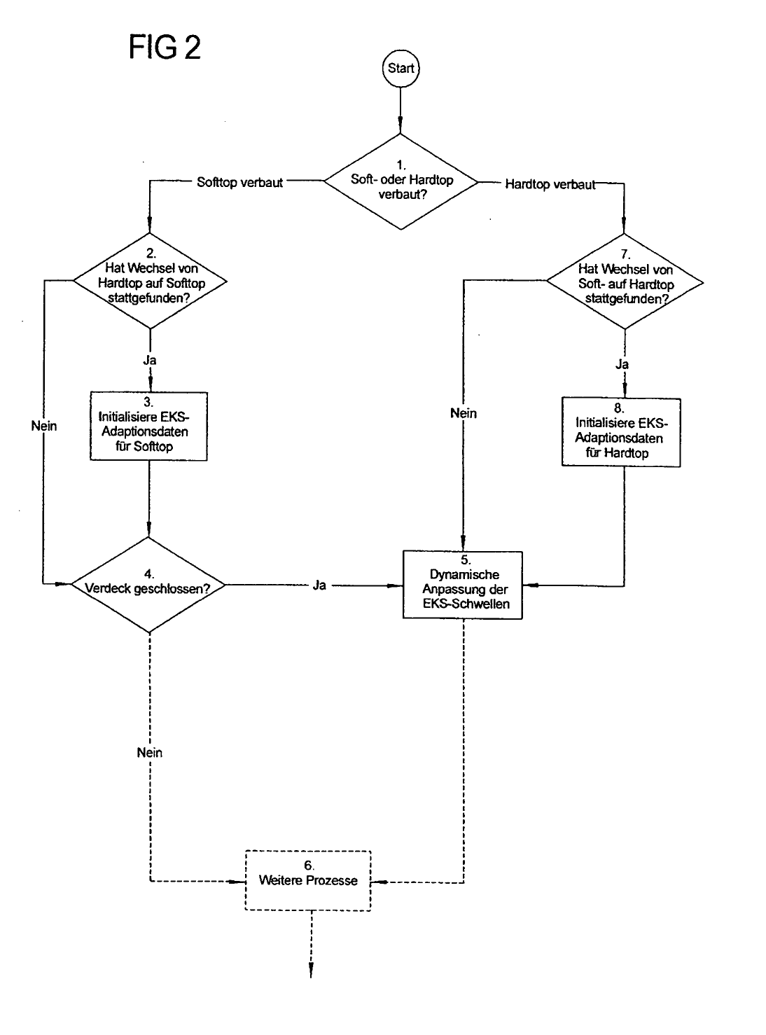

A functional course for different roof types is schematically shown in FIG. 2. After the start of the adjustment of the window lifter, it is first verified in a first step, if a soft or hard top is used. This information about the used roof type is, as shown in FIG. 1, first transmitted to the controlling device by a bus system. In this case, a soft top is used and the rotary course as shown in the upper area of FIG. 1 can be expected, it is verified in a second step, if a change of the roof type from a hard top to a soft top has taken place. This verification of the second step can for example be determined by a flag stored in common electronics memory.

If a change from a hard top to a soft top has taken place during which these different roof type were installed and in particular deinstalled, the reversing criterion for a soft top is adjusted in a third step by loading the respective parameters of the soft top from the common electronics memory into the current register of the micro controller of the controlling electronics. These parameters are thereby initialized as crush protection adaptation data. Crush protection adaptation data means in this case that the used parameters for the soft top are determined by repeated measurements of the window lifter rotary number for the sealing run-in and the parameters are later adapted to level out and adjust the modified condition of the elasticity of the sealing, and in particular, the position of the sealing.

In step 4 of FIG. 2, which directly follows steps 2 and 3, it is verified by a bus information whether the used roof is closed. In the positive case, the parameters for the soft top are dynamically adjusted in step 5 of FIG. 1, by averaging further adjustment motions into the sealing run-in and evaluating the respective restrictions conditioned by the sealing. Following either step 4 or 5, further processes for the calculation of the crush protection can follow in step 6.

If based on step 1 a hard top used, then in step 7 it is verified again whether a change from a soft to hard top has taken place. In the change has taken place, the initialization of the adaptation data read out from the common electronic memory for this hard top occurs again in a eighth step. Following steps 7 or 8, the dynamic adjustment of the crush protection thresholds which form the reversing criterion occurs again in step 5, independent from the query in step 4 because a hard top is always closed.

1. A method for controlling a window lifter of a motor vehicle, comprising the steps of:
determining a position of a window pane of the window lifter;
determining at least one of a current position and condition of a roof of the motor vehicle; and
evaluating in combination the window position and at least one of the roof current position and condition and using the combination for controlling the window lifter.

2. The method according to claim 1, further comprising the step of transmitting a signal, via an interface or a bus, to a control device arranged for effecting the control, the signal characterizing at least one of the position and condition of the roof.

3. The method according to claim 1, wherein the condition of the roof is determined by a plausibility check of the current position of the window pane.

4. The method according to claim 1, wherein the condition of the roof is determined by evaluation of a blocking characteristic at a closed position of the window pane.

5. The method according to claim 1, wherein at least one of a normalization and denormalization of the determined position occurs in reference to a pane closed position in dependence from at least one of the condition and position of the roof.

6. The method according to claim 5, further comprising the step of not performing the denormalization if a blockage is recognized and if the position of the roof is determined as open.

7. The method according to claim 1, wherein the condition of the roof is a roof type.

8. The method according to claim 1, wherein a closing motion of the window lifter is stopped for the control, if the collision of an object or a body part is detected by the closing motion within a detection position area.

9. The method according to claim 8, further comprising the steps of:
measuring a correlation of a collision force in dependence of the detection algorithm for detection parameters dependant upon driving motions, and
adjusting one or more parameters of the detection algorithm in dependence of the type of the roof.

10. The method according to claim 9, wherein a parameter or the parameters influence responsiveness of the detection algorithm.

11. The method according to one of claim 10, wherein the one or more parameters relate to the type of roof and the method further comprises the step of retrieving from a memory the one or more parameters.

12. The method according to claim 11, wherein several parameters form a mapping for the responsiveness.

13. The method according to claim 12, wherein at least one of the parameters forms an offset position for the responsiveness.

14. The method according to claim 12, wherein the parameters are adapted to different sealing characteristics of different types of roofs occurring in cooperation with the window pane.

15. The method according to claim 9, wherein at least one parameter is adapted in dependence of one or more previous adjustments.

16. The method according to claim 15, further comprising the step of adapting the at least one parameter in accordance with place-dependant speeds or place-dependant resistance.

17. A controlling device for a window lifter of a motor vehicle, comprising:
a sensor arranged to detect a position of a window, and
a computer unit coupled to the sensor so as to provide a function for the combined evaluation of a current position of the window and a at least one of a current position and condition of a roof of the motor vehicle.
